(19) United States
(12) Patent Application Publication
(10) Pub. No.: US 2025/0137230 A1
(43) Pub. Date: May 1, 2025

(54) SHOVEL, SOUND OUTPUT SYSTEM FOR SHOVEL, AND REMOTE CONTROL SYSTEM FOR SHOVEL

(71) Applicant: SUMITOMO CONSTRUCTION MACHINERY CO., LTD., Tokyo (JP)

(72) Inventor: Yuiki MATSUHASHI, Chiba (JP)

(21) Appl. No.: 18/930,119

(22) Filed: Oct. 29, 2024

(30) Foreign Application Priority Data
Oct. 31, 2023 (JP) 2023-187089

(51) Int. Cl. E02F 9/20; E02F 9/26; H04R 1/02

(52) U.S. Cl. CPC E02F 9/205; E02F 9/26; H04R 1/028; H04R 2499/13

(57) ABSTRACT

A shovel includes: a lower traveling body; an upper rotatable body rotatable with respect to the lower traveling body; an object detection device that is provided on the upper rotatable body and configured to detect an object existing around a shovel; a sound output device that is provided on the upper rotatable body; and a control device. The control device includes: a memory; and a processor connected to the memory, wherein the processor is configured to obtain a sound signal, and perform control such that sound obtained based on the sound signal is output in a direction a person is detected from the sound output device, upon detection of the person by the object detection device.

### RELATED APPLICATION

The present application is based on and claims priority to Japanese Patent Application No. 2023-187089 filed on Oct. 31, 2023, the entire contents of which are hereby incorporated by reference.

### BACKGROUND

### 1. Field of the Invention

The present disclosure relates to a shovel, a sound output system for the shovel, and a remote control system for the shovel.

### 2. Description of the Related Art

Conventionally, when working with a shovel, there are many cases in which the shovel is operated in cooperation with workers around the shovel. When cooperating with workers around the shovel, there is a situation in which the shovel operator speaks to workers around the shovel. In such a situation, when the operator speaks to a microphone provided in a cab, the sound captured by the microphone is output from a loudspeaker to the periphery of the shovel. As a result, workers around the shovel can recognize what the operator speaks.

Various techniques have been proposed for outputting sound from a shovel. For example, there is a technique for issuing a warning sound to warn a person in the immediate vicinity detected from image information.

### SUMMARY

A shovel according to one embodiment of the present disclosure is provided with a lower traveling body, an upper rotatable body rotatable with respect to the lower traveling body, an object detection device which is provided on the upper rotatable body and configured to detect an object existing around the shovel, a sound output device which is provided on the upper rotatable body, and a control device. The control device includes a memory and a processor connected to the memory, and the processor is configured to obtain a sound signal and perform control such that sound based on the sound signal is output in a direction a person is detected from the sound output device, upon detection of the person by the object detection device.

### BRIEF DESCRIPTION OF THE DRAWINGS

FIG. 1 is a side view of a shovel according to one embodiment;

FIG. 2 is a top view of the shovel according to the embodiment;

FIG. 3 is a diagram schematically illustrating an example of a configuration of the shovel according to the embodiment;

FIG. 4 is a diagram illustrating a concept of a loudspeaker control of the shovel according to the embodiment;

FIG. 5 is a flowchart illustrating a processing procedure for outputting sound by a controller according to the embodiment;

FIG. 6 is a top view of a shovel according to another embodiment;

FIG. 7 is a diagram illustrating a concept of the loudspeaker control of the shovel according to the another embodiment;

FIG. 8 is a diagram illustrating a concept of a sound output system according to yet another embodiment;

FIG. 9 is a diagram illustrating a configuration related to a shovel control and a configuration of a fixed-point loudspeaker according to the yet another embodiment; and

FIG. 10 is a schematic diagram illustrating an exemplary configuration of a remote support system for the shovel according to still another embodiment.

### DETAILED DESCRIPTION

However, when sound is output from the sound output device of the shovel to the periphery of the shovel, the sound is often spread in all directions, and there is a possibility that a large sound can be heard by people other than those working around the shovel. Therefore, there is a possibility that the generated noise reaches beyond the intended surroundings.

According to one aspect of the present disclosure, by outputting sound in a direction in which a person detected around the shovel is present, noise in the direction other than the direction in which the person is present can be reduced.

Hereinafter, embodiments of the present disclosure will now be described with reference to the drawings. The embodiments described below are not intended to limit the disclosure but are exemplary, and not all features and combinations thereof described in the embodiments are necessarily essential to the disclosure. In each of the drawings, the same or corresponding components are denoted by the same or corresponding reference numerals, and the description thereof may be omitted.

In the embodiments of the present disclosure, an example in which a shovel is used as an example of a working machine will now be described, but the disclosure is not limited to the shovel. The present disclosure may be applied to construction machines, standard machines, application machines, forestry machines, or conveyance machines based on hydraulic shovels.

### One Embodiment

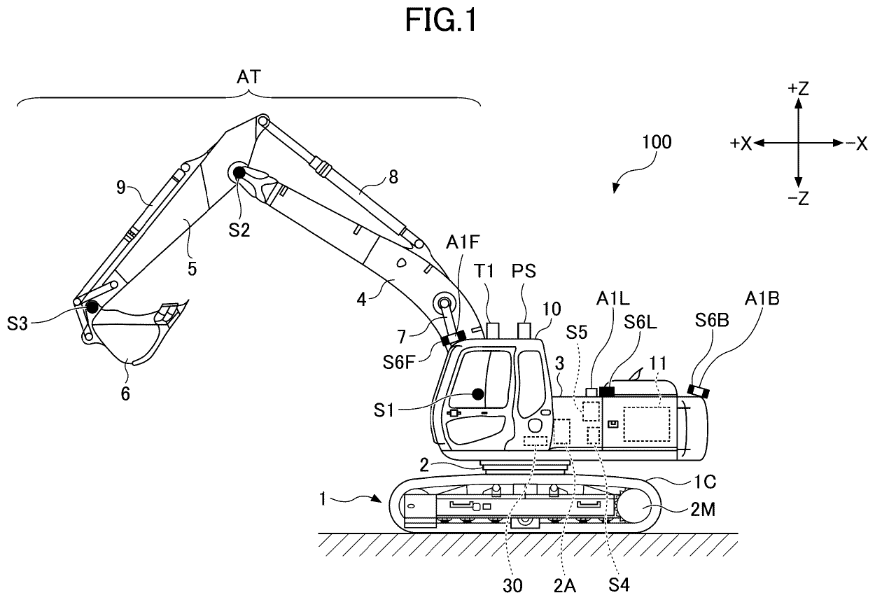

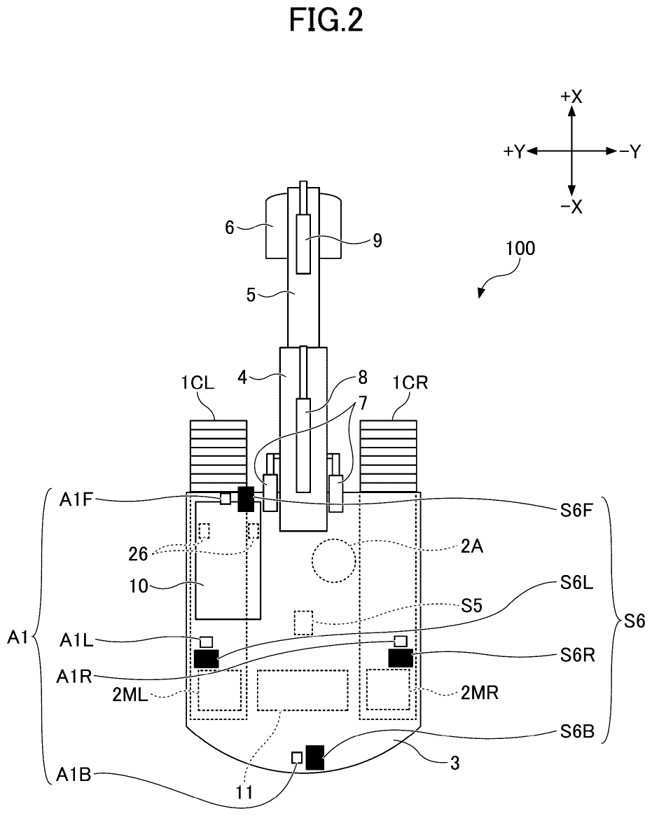

First, an overview of a shovel 100 according to the present embodiment will be described with reference to FIGS. 1 and 2. FIG. 1 is a top view and FIG. 2 is a side view of the shovel 100 according to the present embodiment.

As illustrated in FIGS. 1 and 2, the shovel 100 according to the present embodiment includes a lower traveling body 1, an upper rotatable body 3 mounted on the lower traveling body 1 so as to be able to turn via a turner 2, an attachment AT configured to perform various operations, and a cab 10. Hereinafter, a front of the shovel 100 (upper rotatable body 3) corresponds to a direction in which the attachment to the upper rotatable body 3 extends when the shovel 100 is viewed in a plan view (top view) from directly above along a turning axis of the upper rotatable body 3. Left and right sides of the shovel 100 (upper rotatable body 3) correspond to left and right sides, respectively, as seen by an operator seated in the cockpit of the cab 10.

The lower traveling body 1 includes, for example, a pair of left and right crawlers 1C. Specifically, the crawlers 1C include a left crawler 1CL and a right crawler 1CR. In the lower traveling body 1, the left crawler 1CL and the right crawler 1CR are hydraulically driven by a left traveling hydraulic motor 2ML and a right traveling hydraulic motor 2MR, respectively, so that the shovel 100 travels.

The upper rotatable body 3 rotates with respect to the lower traveling body 1 by the turner 2 being hydraulically driven by a turning hydraulic motor 2A. In other words, the turning hydraulic motor 2A is a turn driver for driving the upper rotatable body 3 as a driven section, and can change a direction of the upper rotatable body 3.

The attachment AT (an example of the attachment) includes a boom 4, an arm 5, and a bucket 6.

The boom 4 is mounted to the front center of the upper rotatable body 3 so as to be elevated, the arm 5 is mounted to a tip of the boom 4 so as to be vertically rotatable, and the bucket 6 is mounted to a tip of the arm 5 so as to be vertically rotatable.

The bucket 6 is an example of a working tool. The bucket 6 is used for, for example, excavation work. Another working tool may be attached to the tip of the arm 5 in place of the bucket 6 according to the contents of the work. The other working tool may be another type of bucket such as a large bucket, a slope bucket, a dredging bucket, or the like. The other working tool may be another type of working tool such as an agitator, a breaker, a grapple, or the like.

The boom 4, the arm 5, and the bucket 6 are hydraulically driven by a boom cylinder 7, an arm cylinder 8, and a bucket cylinder 9 as hydraulic actuators, respectively, by using a hydraulic oil discharged from a main pump 14 (described in the following).

The shovel 100 may be configured such that a part of driven elements such as the lower traveling body 1, the upper rotatable body 3, the boom 4, the arm 5, and the bucket 6 are electrically driven. That is, the shovel 100 may be a hybrid shovel, an electric shovel, or the like in which a part of the driven elements is driven by an electric actuator.

An imaging device S6 is an example of an object detection device. The imaging device S6 is provided on the upper rotatable body 3, and captures images of the periphery of the shovel 100 to obtain image information representing the periphery of the shovel 100. The imaging device S6 includes a camera S6F configured to capture an image of the front of the shovel 100, a camera S6L configured to capture an image of the left side of the shovel 100, a camera S6R configured to capture an image of the right side of the shovel 100, and a camera S6B configured to capture an image of the rear of the shovel 100.

The camera S6F is installed outside the cab 10, such as on a roof of the cab 10 and a side surface of the boom 4. The camera S6F may be installed, for example, on a ceiling of the cab 10, that is, inside the cab 10. The camera S6L is installed at a left end of an upper surface of the upper rotatable body 3, the camera S6R is installed at a right end of the upper surface of the upper rotatable body 3, and the camera S6B is installed to a rear end of the upper surface of the upper rotatable body 3.

The imaging device S6 (cameras S6F, S6B, S6L, and S6R) is, for example, a monocular wide-angle camera having a very wide angle of view. The imaging device S6 includes, for example, an imaging element such as a CCD or a CMOS, and is configured to output a captured image to a display device 40. Furthermore, the image information captured by the imaging device S6 is also obtained by a controller 30.

The imaging device S6 according to the present embodiment shows an example of the object detection device, and any device capable of detecting an object may be used.

As the object detection device, LIDAR may be used to detect an object existing around the shovel 100. The LIDAR measures, for example, distances between 1 million or more points within a monitoring range and the LIDAR. The present embodiment is not limited to a method using LIDAR, but any object detection device capable of measuring the distance between objects may be used. For example, a stereo camera may be used, or a distance measuring device such as a distance imaging camera or a millimeter wave radar may be used. When the millimeter wave radar or the like is used as the object detection device, the distance and direction of the object may be determined from reflected signals by transmitting a large number of signals (laser beams or the like) from the object detection device toward the object and receiving the reflected signals.

Furthermore, two or more types of devices may be used in combination as the object detection device. For example, the imaging device may be combined with the LIDAR, the imaging device may be combined with the millimeter wave radar, or the imaging device may be combined with the stereo camera.

A loudspeaker A1 is a device provided on the upper rotatable body 3, and is configured to convert an input sound signal into a physical sound, in other words, air vibration, and to output the sound. The loudspeaker A1 includes a front loudspeaker A1F configured to output sound from the front of the shovel 100, a left loudspeaker A1L configured to output sound from the left of the shovel 100, a right loudspeaker A1R configured to output sound from the right of the shovel 100, and a rear loudspeaker A1B configured to output sound from the rear of the shovel 100.

The front loudspeaker A1F is installed outside the cab 10, such as on the roof of the cab 10 or on the side of the boom 4. The front loudspeaker A1F may be installed on the ceiling of the cab 10, that is, inside the cab 10, for example. The left loudspeaker A1L is installed at the left end of the upper surface of the upper rotatable body 3, the right loudspeaker A1R is installed at the right end of the upper surface of the upper rotatable body 3, and the rear loudspeaker A1B is installed at the rear end of the upper surface of the upper rotatable body 3.

In the present embodiment, the positions of the loudspeakers A1 and the positions of the imaging device S6 are arranged so as to correspond to each other. For example, the front loudspeaker A1F is arranged adjacent to the camera S6F, the left loudspeaker A1L is arranged adjacent to the camera S6L, the right loudspeaker A1R is arranged adjacent to the camera S6R, and the rear loudspeaker A1B is arranged adjacent to the camera S6B.

The controller (control device) 30 is a control device for controlling the shovel 100. For example, the controller 30 is mainly composed of a computer including a central processing unit (CPU), a read only memory (ROM), a random access memory (RAM), a nonvolatile auxiliary storage medium, various input/output interfaces, and the like. The controller 30 reads a program from a nonvolatile storage medium, loads the program into a volatile storage medium, and causes the CPU to execute the program, thereby realizing various functions. The various functions include, for example, a machine guidance function for guiding a manual operation of the shovel 100 to be performed by an operator. The controller 30 may include a contact avoidance function for automatically or autonomously operating or stopping the shovel 100 in order to avoid contact between the shovel 100 and an object existing in a monitoring range around the shovel 100.

For example, the controller 30 sets a target rotational speed based on an operation of the operator or the like, and performs a drive control for rotating an engine 11 at a constant speed.

A boom angle sensor S1 is installed to the boom 4 and is configured to detect an elevation angle (hereinafter referred to as “boom angle”) of the boom 4 with respect to the upper rotatable body 3, for example, an angle formed by a straight line connecting fulcrums at both ends of the boom 4 with respect to the turning plane of the upper rotatable body 3 in a side view. The boom angle sensor S1 may include, for example, a rotary encoder, an acceleration sensor, a 6-axis sensor, an inertial measurement unit (IMU), etc. The boom angle sensor S1 may also include a potentiometer using a variable resistor, a cylinder stroke sensor for detecting a stroke amount of the hydraulic cylinder (boom cylinder 7) corresponding to the boom angle, etc. Hereinafter, the same applies to an arm angle sensor S2 and a bucket angle sensor S3. A detection signal that corresponds to the boom angle by the boom angle sensor S1 is retrieved by the controller 30.

The arm angle sensor S2 is installed to the arm 5 and is configured to detect a turning angle (hereinafter referred to as “arm angle”) of the arm 5 with respect to the boom 4, for example, an angle formed by a straight line connecting fulcrums at both ends of the arm 5 with respect to the straight line connecting the fulcrums at the both ends of the boom 4 in a side view. A detection signal that corresponds to the arm angle by the arm angle sensor S2 is taken into the controller 30.

A bucket angle sensor S3 is installed to the bucket 6 and detects a turning angle (hereinafter referred to as “bucket angle”) of the bucket 6 with respect to the arm 5, for example, an angle formed by a straight line connecting a fulcrum and a tip (claw) of the bucket 6 with respect to a straight line connecting fulcrums at both ends of the arm 5 in a side view. The detection signal that corresponds to the bucket angle detected by the bucket angle sensor S3 is taken into the controller 30.

A machine body inclination sensor S4 (an example of a posture detector) detects an inclination state of the machine body (upper rotatable body 3 or lower traveling body 1) with respect to a horizontal plane. The machine body inclination sensor S4 is installed to the upper rotatable body 3, for example, and is configured to detect inclination angles (hereinafter referred to as “front-rear inclination angle” or “left-right inclination angle”) of the shovel 100 (that is, the upper rotatable body 3) with respect to two axes in the front-rear direction and the left-right direction. The machine body inclination sensor S4 may include, for example, the rotary encoder, the acceleration sensor, the 6-axis sensor, the IMU, etc. Detection signals by the machine body inclination sensor S4, that correspond to the inclination angles (front-rear inclination angle and left-right inclination angle) are taken into the controller 30.

A turning angle sensor S5 outputs detection information related to a turning state of the upper rotatable body 3. The turning angle sensor S5 detects, for example, a rotation angular velocity and a rotation angle of the upper rotatable body 3 with respect to the lower traveling body 1. The turning angle sensor S5 may include, for example, a gyro sensor, a resolver, a rotary encoder, or the like. Detection signals by the turning angle sensor S5, that correspond to the rotation angle and the rotation angular velocity of the upper rotatable body 3 are taken into the controller 30.

A positioning device PS is configured to measure a position and a direction of the upper rotatable body 3. The positioning device PS is, for example, a global navigation satellite system (GNSS) compass, and detects the position and the direction of the upper rotatable body 3. Detection signals that correspond to the position and the direction of the upper rotatable body 3 are taken into the controller 30. Among the functions of the positioning device PS, the function of detecting the direction of the upper rotatable body 3 may be replaced by an orientation sensor installed to the upper rotatable body 3.

The cab 10 is a cockpit in which an operator rides, and is mounted on a front left side of the upper rotatable body 3.

Note that, as will be described in the following, the cab 10 may be omitted when the shovel 100 is operated by remote control or by fully automatic operation.

A communicator T1 communicates with external devices through a predetermined network including a mobile communication network, a satellite communication network, an Internet network, and the like having a base station as a terminal. The communicator T1 is, for example, a mobile communication module corresponding to mobile communication standards such as long term evolution (LTE), 4th generation (4G), and 5th generation (5G), or a satellite communication module for connecting to a satellite communication network.

The shovel 100 activates an actuator (e.g., hydraulic actuator) in response to an operation by an operator in the cab 10 to drive operating elements (hereinafter, “driven element(s)”) such as the lower traveling body 1, the upper rotatable body 3, the boom 4, the arm 5, and the bucket 6.

Further, instead of or in addition to being operable by an operator in the cab 10, the shovel 100 may be remotely operated from outside the shovel 100. When the shovel 100 is remotely operated, the interior of the cab 10 may be unattended.

The shovel 100 may automatically operate the actuator regardless of content of the operation by the operator. Thus, the shovel 100 realizes a function of automatically operating at least a part of the driven elements such as the lower traveling body 1, the upper rotatable body 3, the boom 4, the arm 5, and the bucket 6, that is, a so-called “automatic drive function” or a “machine control function”.

The automatic driving function may include a function for automatically operating a driven element (actuator) other than a driven element (actuator) to be operated in response to an operation or remote operation of an operation device 26 by the operator, i.e., a so-called “semi-automatic drive function” or an “operation-assisted machine control function”. The automatic driving function may include a function for automatically operating at least a part of the plurality of driven elements (hydraulic actuators) on an assumption that there is no operation or remote operation of the operation device 26 by the operator, i.e., a so-called “fully automatic drive function” or a “fully automatic machine control function”. When the fully automatic drive function is activated in the shovel 100, the interior of the cab 10 may be unattended. The semi-automatic drive function, the fully automatic drive function, and the like may include a mode in which the operation content of the driven element (actuator) targeted for automatic driving is automatically determined in accordance with a predetermined rule. Furthermore, the semi-automatic drive function, the fully automatic drive function, and the like may also include a mode in which the shovel 100 autonomously makes various determinations, and in accordance with a determination result, the operation content of the driven element (hydraulic actuator) targeted for the automatic driving is autonomously determined (so-called “automatic drive function”).

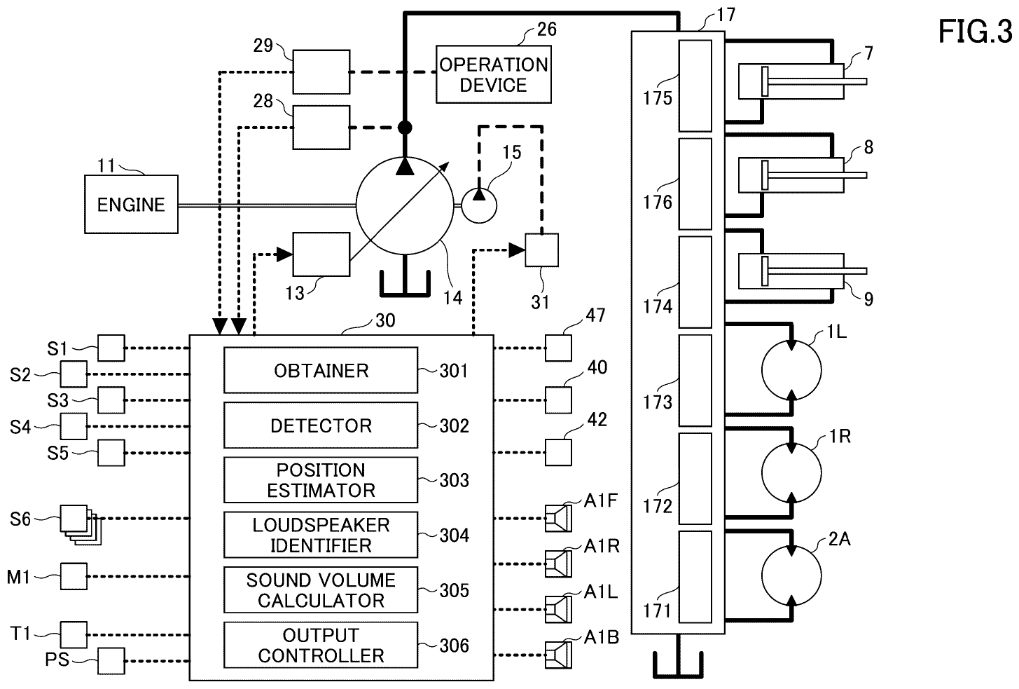

FIG. 3 is a diagram schematically illustrating an example of a configuration of the shovel 100 according to the present embodiment.

In FIG. 3, a mechanical power system, a hydraulic oil line, a pilot line, and an electric control system are indicated by double lines, a solid line, a dashed line, and a dotted line, respectively.

The drive system of the shovel 100 according to the present embodiment includes the engine 11, a regulator 13, the main pump 14, and a control valve unit 17. As described above, the hydraulic drive system of the shovel 100 according to the present embodiment includes the hydraulic actuators such as traveling hydraulic motors 1L and 1R, the turning hydraulic motor 2A, the boom cylinder 7, the arm cylinder 8, and the bucket cylinder 9 for respectively and hydraulically driving the lower traveling body 1, the upper rotatable body 3, the boom 4, the arm 5, and the bucket 6.

The engine 11 is a main power source of the hydraulic drive system. The engine 11 is mounted, for example, on a rear of the upper rotatable body 3. Specifically, the engine 11 rotates at a predetermined target speed under direct or indirect control by the controller 30 described in the following to drive the main pump 14 and a pilot pump 15. The engine 11 is, for example, a diesel engine fueled by diesel oil.

The regulator 13 controls a discharge amount of the main pump 14. For example, the regulator 13 adjusts an angle (tilt angle) of a swash plate of the main pump 14 in accordance with a control command from the controller 30.

Like the engine 11, the main pump 14 is mounted on a rear portion of the upper rotatable body 3, and supplies hydraulic fluid to the control valve unit 17 through a high-pressure hydraulic line. As described above, the main pump 14 is driven by the engine 11. The main pump 14 is, for example, a variable displacement hydraulic pump, and as described above, a stroke length of a piston is adjusted by adjusting the tilt angle of the swash plate by the regulator 13 under the control of the controller 30, thereby controlling a discharge flow rate (discharge pressure).

The control valve unit 17 is a hydraulic control device for controlling the hydraulic system in the shovel 100. In the present embodiment, the control valve unit 17 includes control valves 171 to 176. The control valve 175 includes a control valve 175L and a control valve 175R, and the control valve 176 includes a control valve 176L and a control valve 176R. The control valve unit 17 is configured to selectively supply the hydraulic oil discharged from the main pump 14 to one or more hydraulic actuators through the control valves 171 to 176. The control valves 171 to 176 control, for example, a flow rate of the hydraulic oil flowing from the main pump 14 to the hydraulic actuator and a flow rate of the hydraulic oil flowing from the hydraulic actuator to a hydraulic oil tank. The hydraulic actuator includes the boom cylinder 7, the arm cylinder 8, the bucket cylinder 9, the traveling hydraulic motors 1L and 1R, and the turning hydraulic motor 2A. More specifically, the control valve 171 corresponds to the left traveling hydraulic motor 1L, the control valve 172 corresponds to the right traveling hydraulic motor 1R, and the control valve 173 corresponds to the turning hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generator, and is configured to supply hydraulic fluid to hydraulic control equipment via a pilot line. In the present embodiment, the pilot pump 15 is a fixed displacement hydraulic pump. However, the pilot pressure generator may be realized by the main pump 14. That is, the main pump 14 may have a function of supplying the hydraulic fluid to various types of hydraulic control equipment via the pilot line in addition to a function of supplying the hydraulic fluid to the control valve unit 17 via the hydraulic fluid line. In this case, the pilot pump 15 may be omitted.

A discharge pressure sensor 28 is configured to detect a discharge pressure of the main pump 14. In the present embodiment, the discharge pressure sensor 28 outputs a detected value to the controller 30.

The operation device 26 is a device used by an operator to operate the actuator. The operation device 26 includes, for example, an operation lever and an operation pedal. The actuator includes at least one of the hydraulic actuator or the electric actuator.

An operation sensor 29 is configured to detect an operation content of the operator by using the operation device 26. In the present embodiment, the operation sensor 29 detects an operation direction and an operation amount of the operation device 26 corresponding to each actuator, and outputs a detected value to the controller 30. In the present embodiment, the controller 30 controls an opening area size of a proportional valve 31 in accordance with the output of the operation sensor 29. The controller 30 supplies the hydraulic oil discharged from the pilot pump 15 to a pilot port of the corresponding control valve in the control valve unit 17. The pressure (pilot pressure) of the hydraulic oil supplied to each pilot port is, in principle, a pressure corresponding to the operation direction and the operation amount of the operation device 26 corresponding to each hydraulic actuator. Thus, the operation device 26 is configured to supply the hydraulic oil discharged from the pilot pump 15 to the pilot port of the corresponding control valve in the control valve unit 17.

The proportional valve 31 functioning as a control valve for machine control is arranged in a conduit connecting the pilot pump 15 and the pilot port of the control valve in the control valve unit 17, and is configured to change the flow-path area of the conduit. In the present embodiment, the proportional valve 31 operates in response to a control command output from the controller 30. Therefore, the controller 30 can supply the hydraulic oil discharged from the pilot pump 15 to the pilot port of the control valve in the control valve unit 17 via the proportional valve 31 regardless of the operation of the operation device 26 by the operator.

With this configuration, the controller 30 can operate the hydraulic actuator corresponding to the specific operation device 26 even when the specific operation device 26 is not operated.

A control system of the shovel 100 according to the present embodiment includes the controller 30, the display device 40, an input device 42, a storage medium 47, a microphone M1, and the communicator T1.

The controller 30 (an example of the control device) is provided in the cab 10, for example, and performs a drive control of the shovel 100. The functions of the controller 30 may be implemented by any hardware, software, or a combination thereof. For example, the controller 30 is configured mainly of a microcomputer including the central processing unit (CPU), the read only memory (ROM), the random access memory (RAM), the nonvolatile auxiliary storage medium, and the various input/output interfaces. The controller 30 realizes various functions by executing various programs stored in the ROM or the nonvolatile auxiliary storage medium in the CPU, for example.

For example, the controller 30 sets a target number of rotations based on an operation by an operator or the like, and performs the drive control for rotating the engine 11 at a constant speed.

For example, the controller 30 outputs a control command to the regulator 13 as needed to change the discharge amount of the main pump 14.

For example, the controller 30 controls the machine guidance function for guiding a manual operation of the shovel 100 by an operator through the operation device 26. The controller 30 controls the machine control function for automatically supporting the manual operation of the shovel 100 by the operator through the operation device 26.

A part of the functions of the controller 30 may be achieved by another controller (control device). That is, the functions of the controller 30 may be achieved in a manner distributed by a plurality of controllers. For example, the machine guidance function and the machine control function may be achieved by a dedicated controller (control device).

The display device 40 is provided at a position in the cab 10 that is easily visible from a seated operator, and displays various information images under the control of the controller 30. The display device 40 may be connected to the controller 30 via an on-vehicle communication network such as a controller area network (CAN), or may be connected to the controller 30 via a one-to-one dedicated line.

The input device 42 is provided in the cab 10 within a range within reach of the seated operator, receives various operation inputs by the operator, and outputs signals corresponding to the operation inputs to the controller 30. The input device 42 includes a touch panel mounted on a display of the display device for displaying various information images, a knob switch provided at a tip or tips of one or more lever portions of a plurality of operation levers, a button switch, a lever, a toggle, a rotary dial, and the like provided around the display device 40. Signals corresponding to a content of operations with respect to the input device 42 are taken into the controller 30. The knob switch, and the button switch, the lever, the toggle, the rotary dial, and the like which are provided around the display device 40, are omitted in FIG. 2.

The storage medium 47 is provided in the cab 10, for example, and stores various types of information under the control of the controller 30. The storage medium 47 is, for example, the nonvolatile storage medium such as a semiconductor memory. The storage medium 47 may store information output from various devices during the operation of the shovel 100, or may store information obtained via the various devices before the operation of the shovel 100 is started.

The microphone M1 is provided in the cab 10, for example, and captures sound such as utterance by the operator, and outputs an electric signal (hereinafter, also referred to as sound signal) indicating the sound to the controller 30. The microphone M1 may be provided at any position as long as it is possible to capture the voice of the operator, and may be provided near the display device 40, the input device 42, or a door of the cab, for example.

The microphone M1 is not limited to one provided in the cab 10, but may be provided as a headset or a hands-free microphone to be worn by the operator. The headset or the hands-free microphone can communicate by, for example, Bluetooth (registered trademark). The sound signal representing the sound captured by the headset is input to the controller 30 via the communicator T1 or the like.

### Explanation of Loudspeaker Control of Shovel

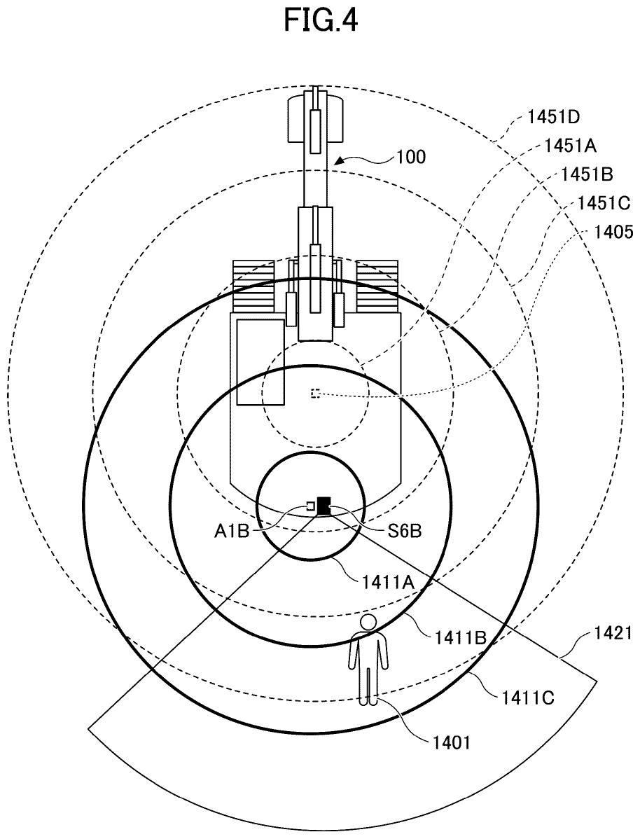

Next, a loudspeaker A1 control of the shovel 100 according to the present embodiment will be described. FIG. 4 is a diagram illustrating a concept of the loudspeaker A1 control of the shovel 100 according to the present embodiment.

FIG. 4 is a diagram illustrating an example where a person 1401 is present behind the shovel 100. The person 1401 is included in an imaging range 1421 of the camera S6B. The example illustrated in FIG. 4 assumes that an operator operating the shovel 100 wants to speak to the person 1401 detected by the camera S6B.

In this case, the operator speaks to the microphone M1. Receiving this, the controller 30 controls the rear loudspeaker A1B that corresponds to the camera S6B to output sound. Ranges 1411A, 1411B, and 1411C in which sound output from the rear loudspeaker A1B is heard are adjusted so as to include at least the person 1401. The rear loudspeaker A1B is provided closer to the person 1401 than the other loudspeakers A1F, A1R, and A1L. Therefore, when the rear loudspeaker A1B outputs sound to the person 1401, the sound volume can be made smaller than when the loudspeakers A1F, A1R, and A1 output sound.

In FIG. 4, a case where the shovel 100 is provided with an existing non-directional loudspeaker 1405 is illustrated. When the non-directional loudspeaker 1405 outputs sound to the person 1401, sound audible ranges 1451A, 1451B, 1451C, and 1451D are adjusted so as to reach the person 1401. In this case, the sound audible ranges are larger than the audible ranges 1411A, 1411B, and 1411C with respect to the sound output from the loudspeaker A1B of the present embodiment.

In other words, in the present embodiment, by outputting sound from the rear loudspeaker A1B, the sound volume can be reduced, and thus noise to the surroundings can be reduced.

### Functional Configuration of Controller

Referring back to FIG. 3, a configuration in which the controller 30 performs control based on a detected person will be described. The controller 30 includes an obtainer 301, a detector 302, a position estimator 303, a loudspeaker identifier 304, a sound volume calculator 305, and an output controller 306, as machine guidance functions and machine control functions.

The obtainer 301 obtains detection results from various sensors provided in the shovel 100. For example, the obtainer 301 obtains image information indicating an imaging result from the imaging device S6. The obtainer 301 also obtains a sound signal representing utterance of an operator from the microphone M1. In the present embodiment, since the microphone M1 is provided in the cab 10, the content of the utterance of the operator in the cab 10 can be transmitted to people around the shovel 100, so that the convenience can be enhanced.

The detector 302 performs detection processing for detecting people around the shovel 100 from the image information obtained by the obtainer 301. Any method may be used for the detection processing for detecting people regardless of a known method. For example, a determination on whether or not a feature extracted from the image information is closer to a feature indicating a person by a predetermined value or more, may be performed.

Further, the detector 302 according to the present embodiment may perform the detection processing for detecting a vehicle, a work machine, or the like present around the shovel 100 from the image information obtained by the obtainer 301. Any method may be used for the detection processing of the vehicle and the work machine or the like regardless of a known method.

When the detector 302 detects a person, the position estimator 303 estimates the position of the person, for example, a direction and a distance in which the person is present with reference to the shovel 100. Any method may be used as an estimation method, and for example, the position estimator 303 may estimate the direction and the distance in which the person is present based on a size of the person in the image information and a position of the person in the image information. When the detector 302 detects a vehicle or a work machine, the position estimator 303 may estimate a position of the vehicle or the work machine, for example, a direction and a distance in which the vehicle or the work machine is present with reference to the shovel 100.

In the present embodiment, the detection of the person and the estimation of the position of the person are not limited to the methods described above, and the detection of the person and the estimation of the position of the person may be performed by using a trained model.

For example, the trained model is configured in conjunction with a neural network. The neural network of the trained model may be a so-called deep neural network having one or more intermediate layers (hidden layers) between an input layer and an output layer. In the neural network, a weighting parameter representing a connection strength between a lower layer is specified for each of a plurality of neurons constituting an intermediate layer. The neural network is configured in such a manner that each neuron in a respective layer outputs a sum of values, that are obtained by multiplying each of the input values received from the neurons of an upper layer by the weighting parameter specified for each of the neurons of the upper layer, to neurons of the lower layer through a threshold function.

After performing machine learning, specifically, deep learning, on the trained model, the weighting parameters of the neural network are optimized.

The training data used in the machine learning includes, for example, image information, information indicating whether or not a person appears in the image information, and information about the position of the person. By performing machine learning using the training data, when the image information is input, the trained model may output information indicating whether or not a person appears in the image information, and the position where the person is present (e.g., direction and distance). Thus, any known method may be used for detecting a person and estimating the position of the person.

The loudspeaker identifier 304 identifies a loudspeaker A1 close to the detected person among the plurality of loudspeakers A1. The loudspeaker identifier 304 according to the present embodiment identifies the loudspeaker A1, that is associated with the imaging device S6 which has captured the image information in which the person is detected. That is, in the present embodiment, since the plurality of imaging devices S6 and the plurality of loudspeakers A1 are associated with each other, it is possible to easily identify which one of the loudspeakers A1 should be used for outputting sound when a person is detected. Therefore, a processing load of the controller 30 can be reduced, and since the loudspeaker A1 close to the detected person can be used to output sound against the detected person, the sound volume of the sound output to the surroundings can be reduced.

The loudspeaker identifier 304 may also identify the loudspeaker A1 close to the detected vehicle or the work machine, among the plurality of loudspeakers A1. Thus, by identifying the loudspeaker A1 based on the detected vehicle or the work machine, the sound can be transmitted to the person in the vehicle or the work machine, in other words, the contents of utterance can be transmitted, and thus the safety can be enhanced.

The sound volume calculator 305 calculates the sound volume for outputting sound from the loudspeaker A1, which is identified by the loudspeaker identifier 304. The sound volume calculator 305 according to the present embodiment calculates the sound volume such that the sound can reach the detected person, based on the position of the loudspeaker A1 for outputting sound and the position of the person identified by the position estimator 303. The sound volume calculator 305 may calculate the sound volume such that the sound reaches the person in a vehicle or a work machine based on the position of the loudspeaker A1 for outputting sound and the position of the vehicle or the work machine identified by the position estimator 303. Any known method may be used as the sound volume calculation method. In the present embodiment, by adjusting the sound volume, the contents spoken by the operator are delivered to a target person or the like, and also, the sound delivered to other people or the like can be reduced. Thus, it is possible to reliably transmit spoken content while also reducing noise in the surroundings.

The output controller 306 controls to output sound based on the sound signal obtained by the obtainer 301 from the loudspeaker A1 identified by the loudspeaker identifier 304, at the sound volume calculated by the sound volume calculator 305.

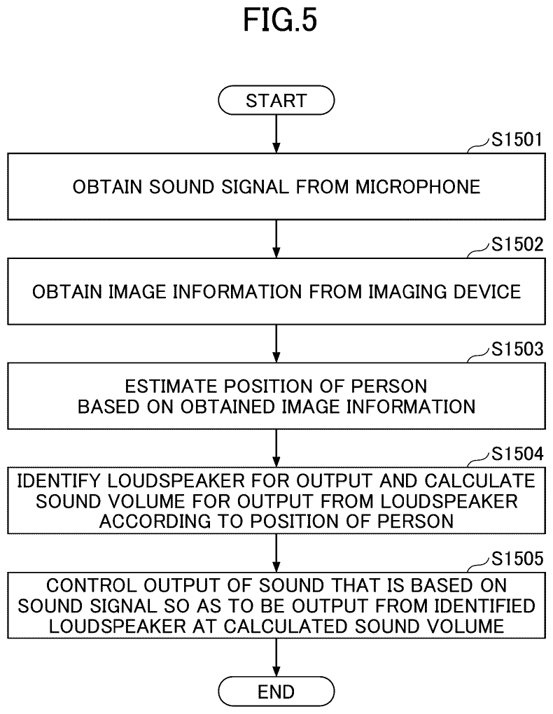

Next, a processing procedure to be carried out by the controller 30 according to the present embodiment will be described. FIG. 5 is a flowchart illustrating the processing procedure for outputting sound by the controller 30 according to the present embodiment.

First, the obtainer 301 obtains a sound signal representing utterance of the operator from the microphone M1 (S1501).

Next, the obtainer 301 obtains image information from the imaging device S6 (S1502).

Then, the detector 302 and the position estimator 303 determine whether a person is present based on image information, and when it is determined that a person is present, estimate a position where the person is present (e.g., direction and distance) (S1503).

Then, the loudspeaker identifier 304 identifies a loudspeaker A1 for outputting sound according to the position where the person is present, and calculates a sound volume output from the loudspeaker A1 by the sound volume calculator 305 (S1504).

Then, the output controller 306 controls to output sound based on the sound signal obtained in S1501 from the identified loudspeaker A1 at the calculated sound volume (S1505).

In the present embodiment, by carrying out the above-described processing procedure, utterance can be made at an appropriate sound volume for the people around the shovel 100. Furthermore, noise that reaches other people can be reduced.

In the present embodiment, a method of adjusting the sound volume output from the loudspeaker A1 in accordance with the position where the person is present has been described. However, in the present embodiment, it is not always necessary to adjust the sound volume output from the loudspeaker A1, that is, by merely outputting the sound from the loudspeaker A1 close to the detected person, the sound reaching other people can be reduced.

### Modified Example 1 of the Present Embodiment

In the embodiment described above, a case in which the sound is output from the loudspeaker A1 corresponding to the direction in which the person is detected, among the four loudspeakers A1, has been described. However, the method is not limited to outputting the sound only when the person is detected. Therefore, in modified example 1 of the present embodiment, a case in which a control that is different from that of the above-described embodiment is performed will be described.

When the operator makes an utterance, the controller 30 according to the present modified example always performs control for outputting a sound that is based on a sound signal corresponding to the utterance, from the front loudspeaker (front-side loudspeaker) A1F of the shovel 100.

When the operator makes an utterance and when the cameras S6R, S6L, and S6B detect a person, the controller 30 performs control so as to output a sound corresponding to the utterance from the loudspeakers (other than the front) A1R, A1L, and A1B, respectively associated with the cameras S6R, S6L, and S6B that have detected the person.

That is, since the operator often speaks to a subject while facing to the subject, the controller 30 controls the front loudspeaker A1F (an example of a loudspeaker in the front area) of the shovel 100 to always output a sound that is based on the sound signal. Then, the controller 30 outputs a sound from the loudspeakers (loudspeakers in areas other than the front area) A1R, A1L, and A1B only when a person is detected from an area other than the front area. In this modified example, since the sound is always output to the front regardless of whether or not presence of a subject is detected in the front of the shovel 100, the convenience can be enhanced.

### Modified Example 2 of the Present Embodiment

In the above-described embodiment and modified example, the case where the number of imaging devices S6 and the number of loudspeakers A1 are associated with each other has been described. However, the above-described embodiment is not limited to the case where the number of imaging devices S6 and the number of loudspeakers A1 correspond to each other.

The number of imaging devices S6 installed is not particularly limited as long as the imaging devices S6 can detect a person present around the shovel 100. The number of loudspeakers A1 in use can be switched according to the number of people detected, and it is sufficient as long as more than one loudspeaker A1 is provided.

When the controller 30 detects a person based on image information from one or more imaging devices S6, it is sufficient as long as estimation of a position of the person and output control of the sound output from a loudspeaker A1 close to the position of the person among the two or more loudspeakers A1 can be performed.

### Another Embodiment

The above-described embodiment and modified example have been described with respect to an example in which a plurality of non-directional loudspeakers A1 are provided. However, the above-described embodiment and the modified example are not limited to an example provided with a plurality of non-directional loudspeakers A1. Therefore, an example provided with a directional loudspeaker will be described in the present embodiment.

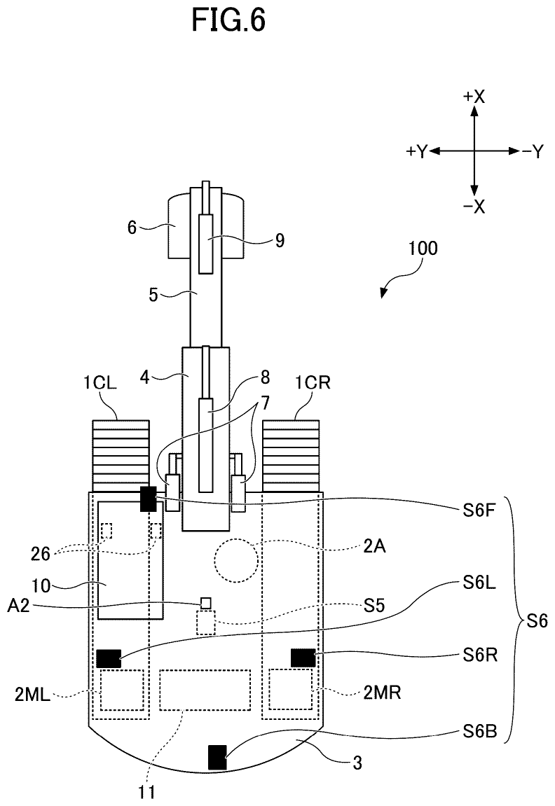

FIG. 6 is a top view of the shovel 100 according to the present embodiment. In a top view of the shovel 100 illustrated in FIG. 6, the same reference numerals are assigned to the same configuration as in the above-described embodiment, and the description thereof will be omitted.

The shovel 100 illustrated in FIG. 6 is an example provided with a loudspeaker A2 instead of the four non-directional loudspeakers A1.

The loudspeaker A2 has a directivity function capable of adjusting a direction in which sound is output according to a control from the controller 30.

Then, the controller 30 detects a person and estimates a position of the person as in the above-described embodiment.

Then, the loudspeaker identifier 304 identifies a range (angle) from which a sound of the loudspeaker A2 is output based on an estimated position of the person. The range (angle) from which the sound is output may be any range as long as it includes at least the direction in which the person is detected, and is determined in accordance with the performance or the like of the loudspeaker A2.

The sound volume calculator 305 calculates a sound volume when a sound is output from the loudspeaker A2. The sound volume calculator 305 according to the present embodiment calculates a sound volume such that the sound can be heard by a person identified by the position estimator 303 based on a positional relationship between the loudspeaker A1 that outputs the sound and the person. In the present embodiment, the sound volume is adjusted so that the sound reaches the target of the operator's utterance and the sound that reaches other people or the like is reduced. Thus, the reliability of the transmission of the spoken content can be enhanced and the noise to the surroundings can be reduced.

The output controller 306 performs control to output sound from the loudspeaker A2, based on the sound signal obtained by the obtainer 301 in a direction specified by the loudspeaker identifier 304 and at the sound volume calculated by the sound volume calculator 305.

In the present embodiment, an example of outputting sound to a person will be described, but the output destination of sound is not limited to a person, and the sound may be output to a vehicle or a work machine.

### Explanation of Loudspeaker Control of Shovel

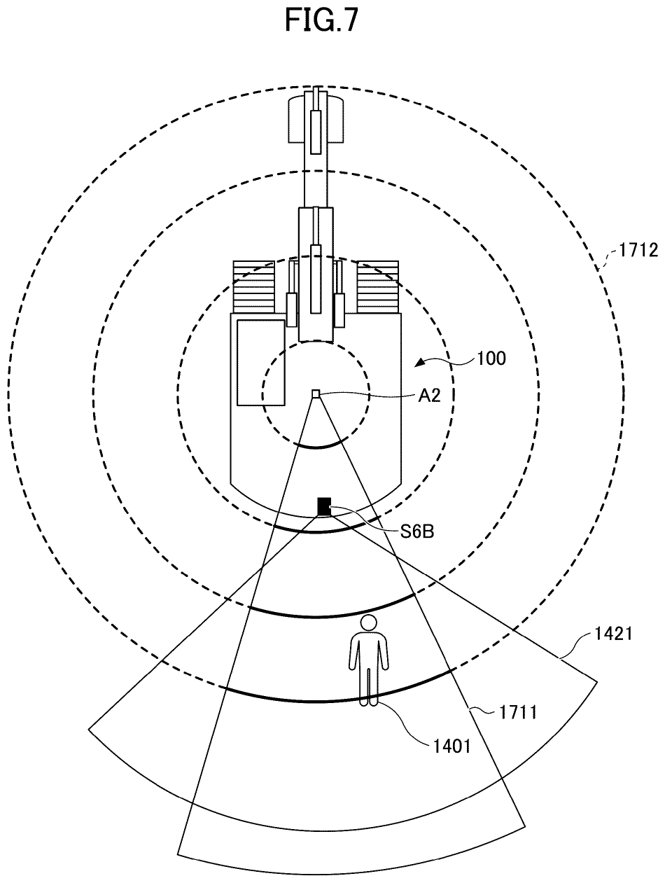

Next, loudspeaker A2 control by the shovel 100 according to the present embodiment will be described. FIG. 7 is a diagram illustrating a concept of the loudspeaker A2 control by the shovel 100 according to the present embodiment.

FIG. 7 is a diagram illustrating an example where the person 1401 is present behind the shovel 100. The person 1401 is included in the imaging range 1421 of the camera S6B. Suppose that an operator operating the shovel 100 wants to speak to the person 1401 detected by the camera S6B.

Then, the controller 30 identifies a range 1711 and a sound volume for outputting the sound from the loudspeaker A2. When the operator speaks to the microphone M1, the loudspeaker A2 outputs the sound to the range 1711. In other words, the controller 30 performs the control to suppress the sound output to the range 1712.

In the present embodiment, the loudspeaker A2 having the directivity function outputs the sound by limiting the output range to a range where the person is present, so that the sound reached by the person present outside the range 1711 can be reduced. In the present embodiment, the number of loudspeakers provided in the shovel 100 can be reduced by using the loudspeaker A2 having the directivity function.

In the present embodiment, the method of adjusting the sound volume output from the loudspeaker A2 in accordance with the position where the person is has been described. However, the present embodiment does not necessarily require adjustment of the sound volume output from the loudspeaker A2, and as long as the loudspeaker A1 is used as the speaker for outputting the sound to the range where the detected person is present, an effect of suppressing the sound reached by other people is provided.

### Modified Example of the Present Embodiment

In the above-described another embodiment, the example in which one loudspeaker A2 that is provided on the shovel 100 and having the directivity function has been described. However, the present embodiment is not limited to the example in which one loudspeaker A2 having the directivity function is provided on the shovel 100. Therefore, a case in which a plurality of loudspeakers A2 having a directivity function are provided will be described as a modified example.

In the present modified example, four loudspeakers A2 are provided. The four loudspeakers A2 are arranged in the same manner as the loudspeaker A1 illustrated in FIGS. 1 and 2, for example.

As in the above-described embodiment, when a person is detected by the imaging device S6, the loudspeaker identifier 304 identifies the loudspeaker A2 close to the detected person among the four loudspeakers A2. The loudspeaker identifier 304 according to the present modified example identifies the loudspeaker A2 corresponding to the imaging device S6 that has captured the image information in which the person is detected. That is, in the present modified example, by associating the plurality of imaging devices S6 with the plurality of loudspeakers A1, the loudspeaker to output sound when a person is detected can be easily identified.

Further, the loudspeaker identifier 304 identifies a range (angle) of outputting sound to the specified loudspeaker A2 based on an estimated position of the person. The range (angle) of outputting sound may be any range as long as it includes at least a direction in which the person is detected, and is determined according to the performance of the loudspeaker A2. The following control is the same as in the above-described embodiment, and description thereof is omitted.

Since the controller 30 according to the present modified example can output sound appropriately in the direction in which the detected person is present by performing the above-described control, it is possible to speak at an appropriate sound volume to the person around the shovel 100. Furthermore, it is possible to reduce the occurrence of noise to other persons.

### Yet Another Embodiment

In the above-described embodiments and the modified examples, the case of outputting sound from a loudspeaker provided on the shovel 100 has been described. However, the above-described embodiments and the modified example are not to limit to the method of outputting sound from a loudspeaker provided on the shovel 100. Therefore, in the present embodiment, a case of outputting sound from a fixed-point loudspeaker provided at a work site will be described.

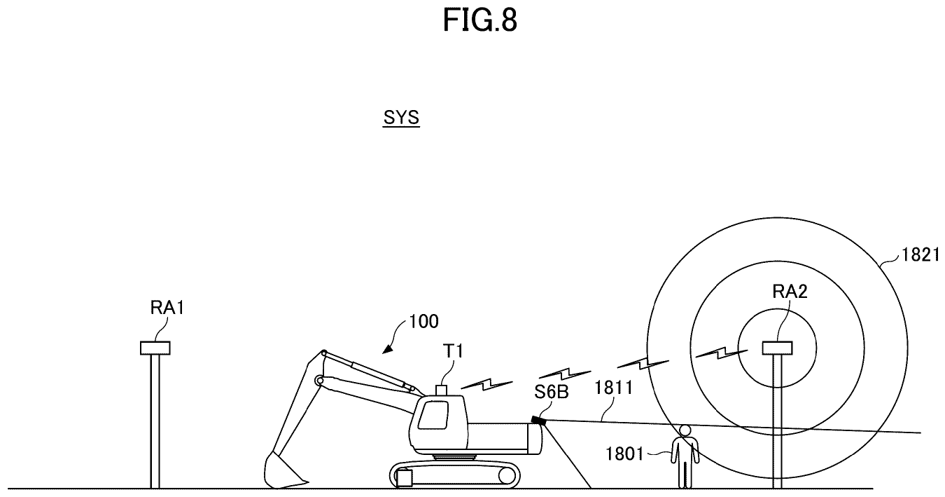

FIG. 8 is a diagram for explaining a concept of a sound output system according to the present embodiment. A sound output system SYS illustrated in FIG. 8 includes the shovel 100 and a plurality of fixed-point loudspeakers RA1 and RA2. In FIG. 8, an example in which the two fixed-point loudspeakers RA1 and RA2 are arranged is illustrated, but the number of fixed-point loudspeakers to be arranged is not limited to two, and may be determined according to the size of a work site or the like.

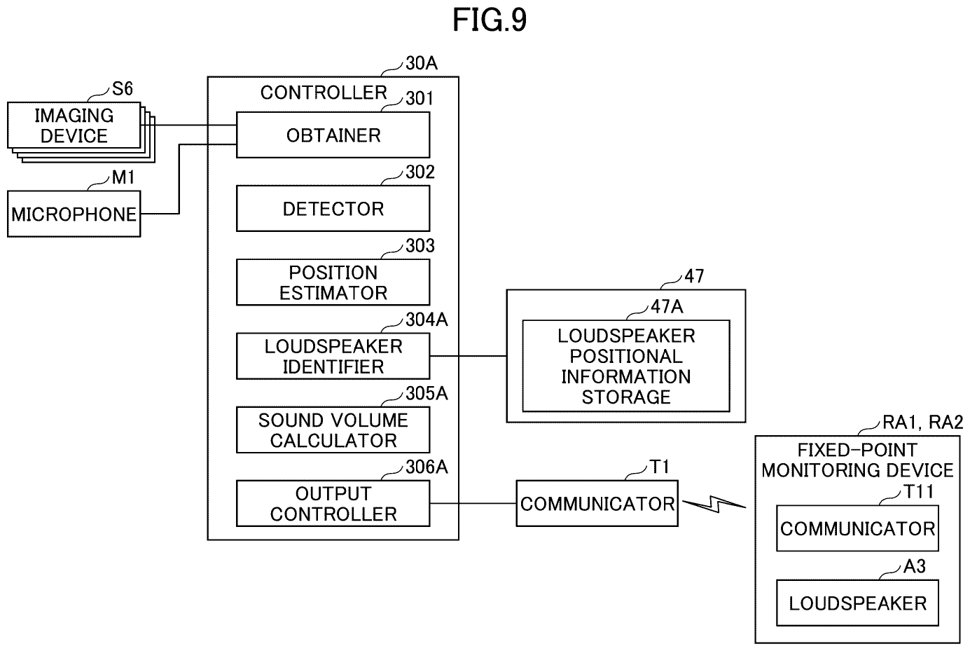

In the present embodiment, it is assumed that an imaging range of the camera S6B of the shovel 100 is an imaging range 1811. Therefore, the controller 30A (see FIG. 9) detects a person 1801 included in the imaging range 1811 based on image information from the camera S6B. The shovel 100 according to the present embodiment includes a controller 30A instead of the controller 30 of the above-described embodiment. The controller 30A includes a configuration for outputting sound from a fixed-point loudspeaker as compared with the controller 30 described above. The controller 30A may include the configuration of the controller 30 described above.

When the operator on board the shovel 100 attempts to speak to the person 1801, the controller 30A of the shovel 100 identifies the fixed-point loudspeaker RA2 close to the person 1801 among the fixed-point loudspeakers RA1 and RA2, and transmits a sound signal from the communicator T1 to a communicator (not illustrated) of the fixed-point loudspeaker RA2.

As a result, the fixed-point loudspeaker RA2 outputs a sound based on the received sound signal. The sound volume output from the fixed-point loudspeaker RA2 (a range 1821 the sound from the fixed-point loudspeaker RA2 can be heard) may be adjusted according to a positional relationship between the fixed-point loudspeaker RA2 and the person 1801. Any adjustment method may be used regardless of the known method. For example, the controller 30A of the shovel 100 may estimate the positional relationship between the fixed-point loudspeaker RA2 and the person 1801 and transmit information indicating the sound volume based on an estimation result to the fixed-point loudspeaker RA2.

Next, a configuration related to the control of the shovel 100 and a configuration of the fixed-point loudspeakers RA1 and RA2 according to the present embodiment will be described. FIG. 9 is a diagram illustrating the configuration related to the control of the shovel and the configuration of the fixed-point loudspeakers RA1 and RA2 according to the present embodiment. The same reference numerals are assigned to the same configuration in the present embodiment as in the above-described embodiments and the modified examples, and the description thereof will be omitted.

As illustrated in FIG. 9, in the shovel 100, the controller 30A is connected to the storage medium 47.

A loudspeaker positional information storage 47A is stored in the storage medium 47. The loudspeaker positional information storage 47A stores information about the positions of the fixed-point loudspeakers RA1 and RA2 present at a work site. The information about the positions of the fixed-point loudspeakers RA1 and RA2 includes, for example, positional information shown by using a world coordinate system.

The controller 30A detects a person and estimates a position of the person based on image information of the imaging device S6, similarly to the controller 30 of the above-described embodiments and the modified examples.

Thereafter, the loudspeaker identifier 304A identifies the fixed-point loudspeakers RA1 and RA2 for outputting sound to the person.

For example, the loudspeaker identifier 304A can recognize positions (for example, directions and distances) of the fixed-point loudspeakers RA1 and RA2 with respect to the shovel 100 from the position and direction of the upper rotatable body 3 measured by the positioning device PS, and the information about the positions of the fixed-point loudspeakers RA1 and RA2 stored in the loudspeaker positional information storage 47A. Therefore, when estimation of the position of the person is performed, the loudspeaker identifier 304A can identify the one close to the person among the plurality of fixed-point loudspeakers RA1 and RA2.

A sound volume calculator 305A adjusts the sound volume according to the positions of the fixed-point loudspeakers RA1 and RA2 identified by the loudspeaker identifier 304A and the estimated position of the person.

Then, an output controller 306A outputs (transmits) a sound signal and information indicating the sound volume to a communicator T11 of the identified fixed-point loudspeakers RA1 and RA2 via the communicator T1.

The fixed-point loudspeakers RA1 and RA2 include the communicator T11 and the loudspeaker A3. The loudspeaker A3 according to the present embodiment is a non-directional loudspeaker, but may be a directional loudspeaker.

When the communicator T11 receives the sound signal and information indicating the sound volume, the loudspeaker A3 outputs sound based on the received sound signal and information indicating the sound volume.

In the present embodiment, among the fixed-point loudspeakers RA1 and RA2 provided at places other than the shovel 100, the sound is output from the fixed-point loudspeaker closer to the detected person. Accordingly, the sound can be reliably delivered to the person and the noise generated at a place away from the person can be reduced. Since other people can more clearly hear sounds other than the sound directed towards the person, the safety can be enhanced.

### Still Another Embodiment

In the present embodiment, a description will be given of a case where an operator remotely operates the shovel 100.

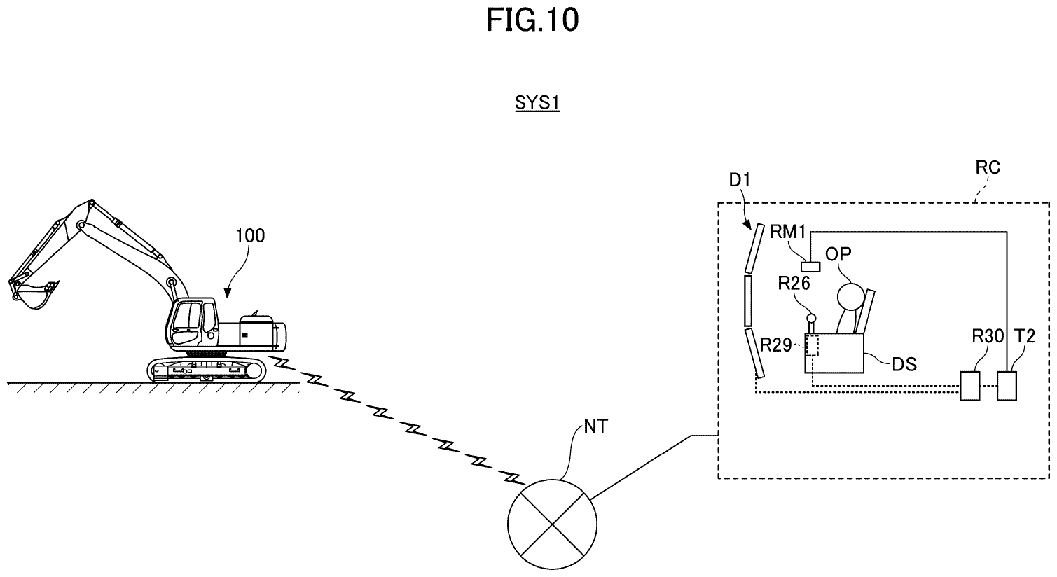

FIG. 10 is a schematic diagram illustrating a configuration example of a remote support system SYS1 of the shovel 100 according to the present embodiment. In the example illustrated in FIG. 10, the shovel 100 and a remote control room RC are connected via a communication network NT. Thus, information can be transmitted and received between the shovel 100 and the remote control room RC.

The shovel 100 transmits detection results from various sensors provided in the shovel 100 to the remote control room RC by using the communicator T1 provided in the shovel 100. For example, the shovel 100 transmits image information picked up by the imaging device S6 to the remote control room RC.

In the remote support system SYS1 according to the present embodiment, the remote control room RC is provided. The remote control room RC is provided with a display device D1, an operation device R26, an operation sensor R29, an operation seat DS, a remote controller R30, a communicator T2, and a microphone RM1.

The remote controller R30 displays the image information sent from the shovel 100 on the display device D1. Thus, an operator OP present in the operation seat DS can confirm the situation around the shovel 100 even when the operator is in the remote control room RC.

The display device D1 displays a screen based on the information sent from the shovel 100 so that the operator OP in the remote control room RC can visually confirm a situation around the shovel 100. With the display device D1, the situation of a work site including the situation around the shovel 100 can be confirmed even though the operator is in the remote control room RC.

The operator OP present at the operation seat DS of the remote control room RC operates the operation device R26. The operation sensor R29 detects an operation content received by the operation device R26. The controller 30 generates a control signal corresponding to the operation content. The communicator T2 transmits the generated control signal to the shovel 100. By the remote controller R30 transmitting the control signal, the shovel 100 can be remotely operated.

As in the controller 30 of the one embodiment, the remote controller R30 includes the obtainer 301, the detector 302, the position estimator 303, the loudspeaker identifier 304, the sound volume calculator 305, and the output controller 306.

For example, the obtainer 301 acquires image information from the communicator T2 and a sound signal from the microphone RM1.

Then, as in the one embodiment, the remote controller R30 determines a loudspeaker A1 for outputting sound and a sound volume. Then, the output controller 306 transmits the sound signal, information for identifying the identified loudspeaker A1, and information indicating the sound volume to the shovel 100 via the communicator T2.

Thus, as in the one embodiment, sound can be output from the loudspeaker A1 close to the person present around the shovel 100.

In the present embodiment, the case where the same control as in the one embodiment is performed by remote control has been described. However, in the present embodiment, the remote control is not limited to the case where the same control as in the one embodiment is performed, and the remote control may be applied to the case where the same control as in the another embodiment to the yet another embodiment or the modified examples of these embodiments is performed.

In the present embodiment, the shovel 100 can be controlled even from a remote location by performing the operation in the remote control room RC. Therefore, it can be made easy to secure an operator of the shovel 100 even when the work site is at a remote place.

In the present embodiment, utterance of the operator in the remote control room RC can be output from the loudspeaker A1 close to the person around the shovel 100. Therefore, the safety can be enhanced and the noise generated in the surroundings can be reduced.

### Modified Example of the Present Embodiment

The above-described embodiment has described the case where the operator does not board the cab 10 and performs remote control from the remote control room RC. However, the above-described embodiment does not limit the case where the operator does not board the cab 10, to the case where remote control is performed, and an autonomous control may be performed by the shovel 100.

In this case, a remote monitoring system for monitoring the shovel 100 performing autonomous control may exist. A supervisor may monitor the shovel 100 from a monitoring device provided in the remote monitoring system. The supervisor may check the image information captured from the imaging device S6 of the shovel 100. The supervisor may speak to the person detected around the shovel 100 from a microphone provided in the monitoring device. In this case, as in the above-described embodiments, sound may be output from the loudspeaker A1 close to the person. Description of the processing procedure for outputting sound is considered to be the same as those in the above-described embodiments and thus the description is omitted. Thus, it is possible to enhance safety and reduce ambient noise.

### Effect

In the above-described embodiments and the modified examples, when a person is detected by the object detection device (for example, the imaging device S6, etc.) provided on the shovel, control is performed to output sound based on a sound signal from a loudspeaker in a direction in which the person is detected. By this control, it is possible to transmit sound to the detected person and to reduce sound output to an area where the detected person is not present. That is, since the sound reached by the area other than where the detected person is present can be reduced, surrounding sound can be easily heard in the area, and thus the safety can be enhanced.

According to one aspect of the present disclosure, safety is enhanced by reducing ambient noise.

Although the embodiments of the shovel, the sound output system for the shovel, and the remote control system for the shovel according to the present invention have been described above, the present invention is not limited to the above embodiments. Various changes, modifications, substitutions, additions, deletions, and combinations thereof are possible within the scope of the claims. These also naturally fall within the technical scope of the present invention.

What is claimed is:

1. A shovel, comprising:
a lower traveling body;
an upper rotatable body rotatable with respect to the lower traveling body;
an object detection device that is provided on the upper rotatable body and configured to detect an object existing around a shovel;
a sound output device that is provided on the upper rotatable body; and
a control device, wherein the control device includes:
a memory; and
a processor connected to the memory, wherein
the processor is configured to obtain a sound signal, and
perform control such that sound obtained based on the sound signal is output in a direction a person is detected from the sound output device, upon detection of the person by the object detection device.

2. The shovel according to claim 1, wherein
a plurality of sound output devices, each being the sound output device, are provided on the upper rotatable body, and each of the plurality of sound output devices is provided at a different position on the upper rotatable body, and
the processor is configured to perform control to output the sound signal from the sound output device close to the person detected among the plurality of sound output devices, upon detection of the person by the object detection device.

3. The shovel according to claim 2, wherein
a plurality of object detection devices, each being the object detection device, is provided on the upper rotatable body,
the plurality of object detection devices are disposed such that each position of the plurality of object detection devices corresponds to each position of the plurality of sound output devices, and
the processor is configured to perform control to output the sound signal from the sound output device corresponding to the object detection device that has detected the person, upon detection of the person by the object detection device.

4. The shovel according to claim 2, wherein
the sound output device is provided at least in a front region and a region other than the front region of the shovel, and
the processor is configured to control the sound output device provided in the front region to always output the sound signal, and to output the sound signal from the sound output device provided in the region other than the front region, upon detection of the person in the region other than the front region.

5. The shovel according to claim 1, wherein
the sound output device includes a directivity function capable of controlling a direction in which sound is output, and
the processor is configured to control the sound output device such that the sound signal is output in a predetermined range including at least a direction in which the person is detected, upon detection of the person by the object detection device.

6. The shovel according to claim 5, wherein
the sound output device includes the directivity function, and a plurality of sound output devices are provided on the upper rotatable body, and each of the plurality of the sound output devices is provided at a different position on the upper rotatable body, and
upon detection of the person by the object detection device, the processor is configured to control output of the sound signal in a predetermined range that includes at least a direction the person is detected, from the sound output device close to the person detected, among the sound output devices.

7. The shovel according to claim 1, wherein
the processor is configured to perform control to adjust a sound volume output from the sound output device, in accordance with a positional relationship between the person and the shovel based on a detection result, upon detection of the person by the object detection device.

8. The shovel according to claim 1, wherein
the processor is configured to perform control to output the sound signal from the sound output device, in a direction in which a vehicle or a work machine is detected, upon detection of the vehicle or the work machine by the object detection device.

9. The shovel according to claim 1, wherein
a sound capturing device is provided in a cab of the shovel, and
the processor obtains the sound signal from the sound capturing device.

10. The shovel according to claim 1, further comprising:
a communicator configured to receive the sound signal from an external device, and
the processor obtains the sound signal received by the communicator.

11. A sound output system for a shovel, comprising:
a sound output device, a plurality of the sound output devices being provided in a plurality of regions to which a shovel is movable, and the sound output device includes a first communicator, and a sound output part configured to output a sound signal received by the first communicator, and
a shovel that includes, a lower traveling body, an upper rotatable body rotatable with respect to the lower traveling body, an object detection device that is provided on the upper rotatable body and configured to detect an object existing around the shovel, a control device, and a second communicator, wherein
the control device is configured to obtain a sound signal, and
the second communicator is configured to transmit the sound signal obtained by the control device to the first communicator of the sound output device close to a person detected, among the plurality of the sound output devices, upon detection of the person by the object detection device.

12. A remote control system for a shovel, comprising:
a control device that is in remote including, a sound capturing device; and a first communicator configured to transmit a sound signal of sound captured by the sound capturing device; and
a shovel that includes, a lower traveling body, an upper rotatable body rotatable with respect to the lower traveling body, an object detection device that is provided on the upper rotatable body and configured to detect an object existing around the shovel, a control device, and a second communicator configured to receive the sound signal from the first communicator, wherein
the control device includes:
a memory; and
a processor connected to the memory, wherein
the processor is configured to
obtain the sound signal from the second communicator, and
output sound from the sound output device based on the sound signal obtained, in a direction in which a person is detected upon detection of the person by the object detection device.
